(19) United States
(12) Patent Application Publication
(10) Pub. No.: US 2023/0001732 A1
(43) Pub. Date: Jan. 5, 2023

(54) Bookmark Card and Display

(71) Applicant: José Félix Botella Belda, Alicante (ES)

(72) Inventor: José Félix Botella Belda, Alicante (ES)

(21) Appl. No.: 17/885,121

(22) Filed: Aug. 10, 2022

Related U.S. Application Data
(63) Continuation-in-part of application No. 35/506,382, filed on May 4, 2018, now Pat. No. D881279.

(51) Int. Cl. B42D 9/00; G09F 1/06

(52) U.S. Cl. CPC B42D 9/007; G09F 1/06

(57) ABSTRACT

The invention set forth herein is a bookmark card configured into several sections by creases and two openings. Once the lower sections are folded and the openings are aligned, the latter are connected by inserting the article to be presented, thus forming its dual-use upright configuration for display of small gifts and/or promotional items and its collapsed or unfolded configuration as a bookmark. The end consumer obtains two articles in one: a presentation support and a bookmark card, without having to use glue to assemble it in the upright configuration and avoiding the production of unnecessary waste after presentation of small articles.

### CROSS REFERENCE TO THE RELATED APPLICATIONS

U.S. DESIGN Pat. No. D 881,279 and its divisional design applications 29/825,832 and 29/825,740, the descriptions of which are attached hereto as references. The novelty of the present invention provides the benefit of its double utility, not generating waste and adapting to a wide variety of articles.

### TECHNICAL FIELD

Embodiments of the present invention generally relate to the field of display case packaging and containers for presenting gifts and promotional articles to the end user.

### BACKGROUND OF THE INVENTION

The presentation of gift items both for events and for personal and consumer gifts is accompanied by large quantities of waste materials. Boxes, bags, glues, seals . . . all these single-use items generate significant amounts of waste and pollutants. A confluence of current trends and needs are driving consumers raise their awareness of the amount of waste they generate. Consequently, there is a need for reusable containers that can be assembled cleanly and simply and that do not require the use of glues or other additional components. Pursuant to the above, the use of articles that generate zero residues is necessary to reduce the waste generated by consumption of single-use containers, thus refraining from contributing to increased environmental pollution.

### SUMMARY OF THE INVENTION

The present disclosure provides a bookmark card that shifts between a collapsed or dismantled bookmark card configuration and a upright display configuration for small gift articles to address the aforesaid problems.

The following is the technical solution that the present invention proposes to solve the problems mentioned above:

A bookmark card and a display case that includes a flat cardboard main body punched into a shape that defines various sections by means of creases and a decorative upper part. The sections are folded along predefined creases for assembly of a display case for presentation of small articles.

The bookmark card and display case are composed of 4 lower and 1 upper sections. The lower sections are those configured to form the structural base of the display case.

The bookmark card and display case is provided with 2 holes in the lower sections at opposite ends that are connected to each other by inserting the article to be presented. Both the components—the structure and the article to be presented—are thus secured.

The bookmark card and display case is configured with an upper section as a variable decorative component, visible as a promotional claim panel and decorative support both in the upright display case configuration and the collapsed or dismantled bookmark configuration. In this latter configuration, said upper part is the section that protrudes to mark the place in the book.

The bookmark card and display case does not require the use of adhesives for assembly.

The bookmark card and display case, in which the card body is made of sufficiently thick cardboard to provide the appropriate rigidity to the display case.

The following are the advantages of the present disclosure compared to the state of the art:

Due to its dual configuration, the bookmark card and display case provides retailers and consumers with two items in one. It is provided in the collapsed configuration for shipment and, once received by the retailers and/or consumers, is folded appropriately and the assembled case is used to present small articles. When the end consumer receives the display case with the presented article and removes it, the configuration returns to its unfolded form as a bookmark card. Thus the final consumer obtains two articles in one and avoids generating unnecessary waste.

The embodiments of the present invention further include an assembly method by folding sections that form the walls of the display case and openings that connect the sections. By inserting the article to be presented, the display case is assembled without requiring the use of glues or other kinds of adhesive, thus simplifying assembly for retailers and consumers. Consequently, the invention prevents unnecessary production of waste. The following are brief descriptions of the drawings in the description of the embodiments in order to more clearly illustrate the technical solutions of the present disclosure.

### BRIEF DESCRIPTION OF THE DRAWINGS

FIG. 1 is an unfolded front view of Embodiment 1 of the present disclosure.

FIG. 2 is a perspective view of the folding process of Embodiment 1 of the present description.

FIG. 3 is a front view of the display case in its upright position ready to receive the article and complete assembly of Embodiment 1 of the present description.

FIG. 4 is a perspective view of the display case in the upright position for receiving the article and completing assembly of Embodiment 1 of the present disclosure.

FIG. 5 is a side view of the display case receiving the article and being assembled as Embodiment 1 of the present disclosure.

FIG. 6 is an unfolded front view of Embodiment 2 of the present disclosure.

### DETAILED DESCRIPTION OF THE INVENTION

Detailed embodiments of the present invention are described herein. However, it must be understood that the embodiments thus described are merely examples of the invention which may be embodied in various alternative forms. The figures are not necessarily to scale and certain features may be exaggerated or minimized to show details of particular components. Therefore, the specific structural and functional details set forth herein should not be construed as limiting the embodiments but merely as a representative basis for showing a person skilled in the art how to employ the present invention in various ways.

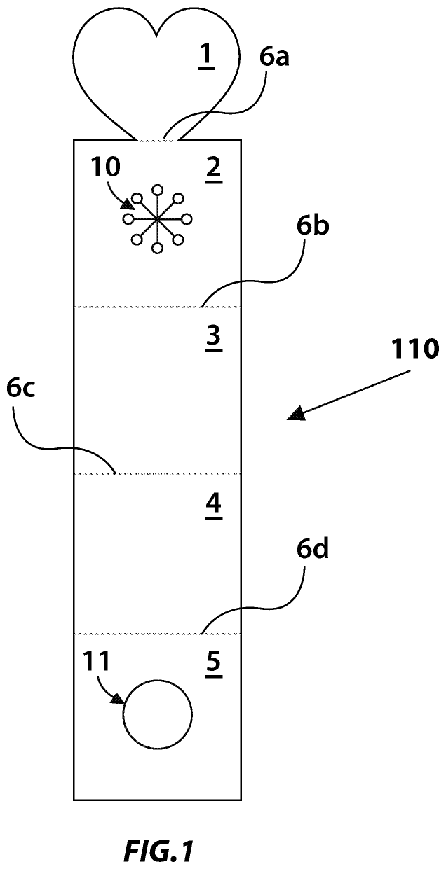

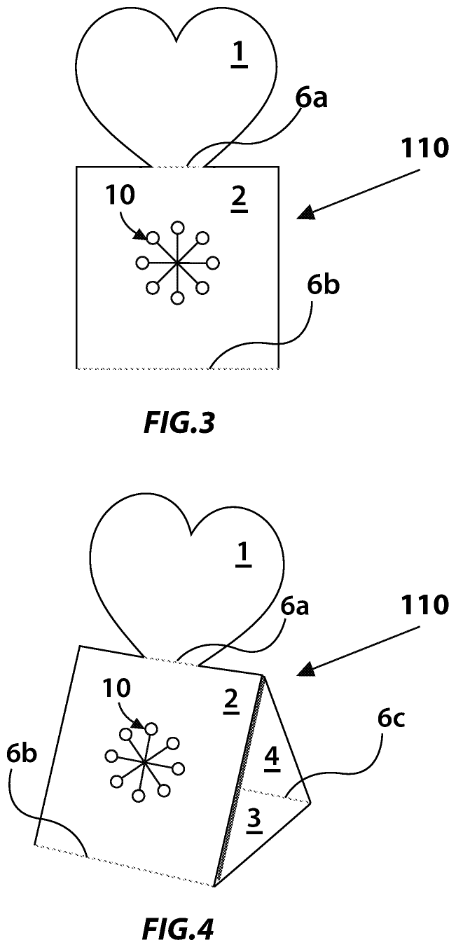

Referring to FIGS. 1 to 6, the bookmark card and display case is a main body made of punched cardboard of a suitable length and width. Its area is into sections 1, 2, 3, 4 and 5 by means of creases 6a, 6b, 6c and 6d for configuration in the collapsed or dismantled form of a bookmark card and, by means of the creases, the sections are folded along pre-defined lines for upright assembly of a display case. The punched opening in section 2 with a plurality of tabs 10 and the opening 11 in section 5 with a clean cut, once aligned and the article to be presented having been inserted, the two openings are connected and the pyramidal structure is assembled without requiring glues or other means of adhesion. The decorative section 1 with its variable motif caps the pyramidal structure. Configuring a convertible bookmark card that shifts between two configurations, an upright support configuration and a collapsed or unfolded bookmark card configuration.

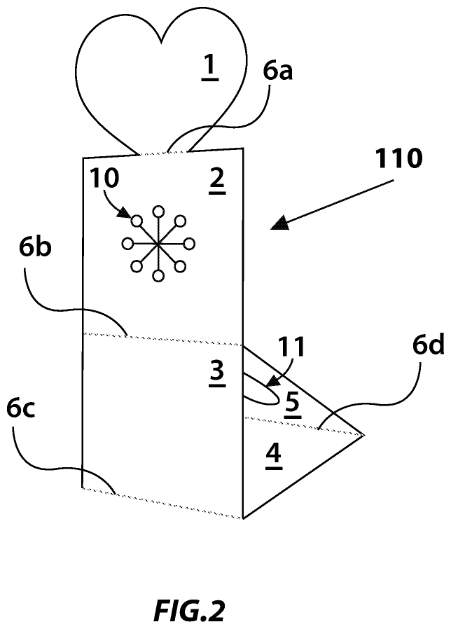

The bookmark card and display case is divided into sections 1, 2, 3, 4 and 5 made up of creases 6a, 6b, 6c and 6d. Sections 2, 3, 4 and 5 form the base structure and walls of the container for assembly of the upright display case configuration so that sections of 3, 4 and 5 are folded towards the rear to form the final pyramidal structure as shown in FIG. 2 of Embodiment 1. The front part of section 5 rests on the rear of section 2. The front part of section 3 is the base of the pyramidal structure, leaving the front part of section 4 as the rear part of the pyramidal structure as shown in FIG. 4 of Embodiment 1.

The bookmark card and display case is provided with two openings at the opposite ends of sections 2, 3, 4 and 5, the opening 10 in section 2 and the opening 11 in section 5, On aligning these two openings, the front part of section 5 is left facing the rear part of section 2 and, the two openings being aligned, the structure can be fixed in place. The opening 10 that covers the opening 11 has plurality punched tabs as shown in FIG. 4 of Embodiment 1.

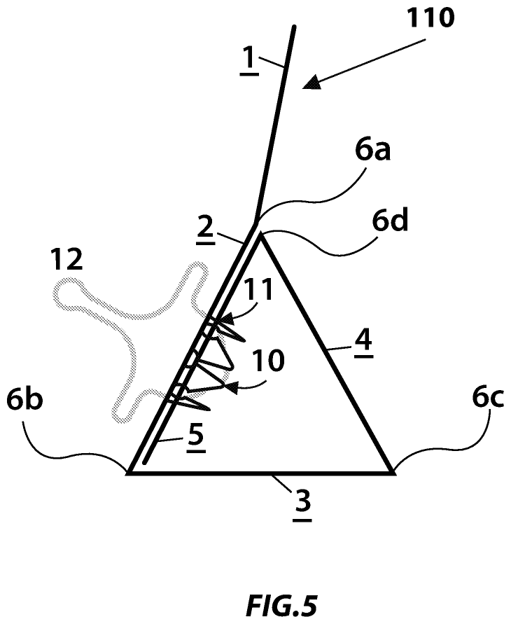

The clean-cut opening 11 is ready for insertion of the article to be presented through the opening 10, and this pushes the tabs of the opening 10 towards the interior of the structure and the article is fixed as shown in FIG. 5 of Embodiment 1. The article 12 is shown in FIG. 5 of Embodiment 1 by way of example; in this case the article shown is a spinning top. The article is fastened and in turn acts as closure device for the structure.

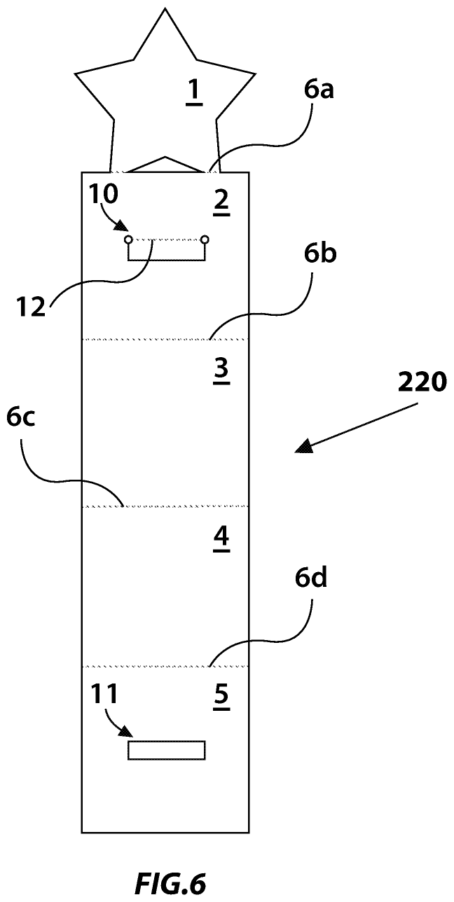

The bookmark card and display case can present any object of suitable size and openings 10 and 11 can be adapted for optimum fastening. In FIG. 6 of Embodiment 2 the openings 10 and 11 have been modified to present a flat object such as a ring. The shape and the number of tabs of the opening 10 can be varied for proper fastening. Section 1 in FIG. 6 of Embodiment 2 has changed its decorative shape, which it can vary endlessly to adapt to the needs of each particular case. Section 1 is the visible section as a promotional display panel and decorative support both in the upright display case configuration and in the collapsed or dismantled bookmark configuration. In this latter configuration, said part is the section that protrudes to mark the place in the book.

The body of the bookmark card and display case is made of sufficiently strong cardboard to act as a support, container, packaging and bookmark.

Sections 2-5 of the bookmark card are basically square and may vary in shape and size.

The figures may represent exemplary configurations for the invention to aid a proper understand of the features and functions that may be developed on the basis of the invention. The invention is not limited to the configurations illustrated herein but can be implemented using a variety of alternative configurations.

Furthermore, although the invention is described above in terms of various exemplary embodiments and implementations, it must be understood that the various features and functions described in one or more of the individual embodiments are used as illustrations. However, instead of these features or functions, one or more other different versions of the invention may be applied alone or in combination, regardless of whether said embodiments have been described or said features presented herein or not as part of the embodiment described. Therefore, the breadth and scope of the present invention, especially the following claims, are not limited to any of the exemplary embodiments described above.

Terms and phrases used in this document and variations thereof, unless expressly stated otherwise, shall be construed as open rather than limited. The term “example” is used to provide exemplary instances of the subject matter under discussion, not an exhaustive or delimited list thereof. Likewise, a group of elements linked with the conjunction “and” shall not be read as requiring that each and every one of said elements be present in the group, but should be read as “and/or” unless expressly indicated otherwise. Similarly, a group of elements linked with the conjunction “or” should not be interpreted as requiring mutual exclusivity between members of said group, but should also be read as “and/or” unless expressly stated otherwise. In addition, although the article, elements, or components of the disclosure may be described or claimed in the singular, the plural is understood to be within the scope thereof unless limitation to the singular is explicitly stated.

1. A bookmark card that can shift between a collapsed or dismantled bookmark card configuration and an upright display-case configuration for small gifts. The configuration of the bookmark card is composed of several sections formed by creases. The upper section is intended as a decorative promotional panel and the lower sections are intended to form the base of the upright display structure. The lower sections are symmetrical with each other, basically square and joined by folding. Two openings are punched at opposite ends of the lower sections: the upper one has plurality of tabs and the lower one is a clean-cut punched opening. To obtain the upright display configuration, the central crease of the lower sections is folded towards the rear so that the frontal surface of the lower section rests on the rear surface of the upper section, thus aligning the two openings. On inserting the article through the opening in the upper section, the tabs move towards the interior of the display case, connecting the tabs on the inside edge of the opening in the lower section. Thus, the upright display configuration is assembled in a pyramidal structure and the article to be presented is fastened in the display case. Therefore, once the upright display function is no longer needed and the article has been removed from the display case, the invention returns to its collapsed or dismantled configuration as a bookmark card.

2. The bookmark card of claim 1 is made of cardboard sufficiently thick to form a solid body with a stable structure in its upright configuration and a durable bookmark card in its collapsed configuration.

3. The bookmark card of claim 1 does not require the use of adhesives to assume its upright display configuration.

4. One method for producing the convertible bookmark card is by means of punching the cardboard piece into a suitable length and width by dividing its surface into sections by creases. The lower sections for the base of its upright display case configuration and the upper section as a decorative promotional claim. In the symmetrical lower sections, two openings of a size suitable to properly fasten the article to be presented are punched at their opposite ends. Once the lower sections are folded and the openings are aligned they are joined by inserting the article to be presented.

5. A bookmark card that can shift between a collapsed or dismantled bookmark card configuration and an upright display-case configuration for small gifts. The configuration of the bookmark card is composed of several sections formed by creases. The upper section is intended as a decorative promotional panel and the lower sections are intended to form the base of the upright display structure. The lower sections are symmetrical with each other, basically square and joined by folding. Two openings are punched at opposite ends of the lower sections: the upper one with a tab and the lower one with a clean-cut punched opening. To obtain the upright display configuration, the central crease of the lower sections is folded towards the rear so that the frontal surface of the lower section rests on the rear surface of the upper section, thus aligning the two openings. On inserting the article through the opening in the upper section, the tabs move towards the interior of the display case, connecting the tabs on the inside edge of the opening in the lower section. Thus, the upright display configuration is assembled in a pyramidal structure and the article to be presented is fastened to the display case. Therefore, once the upright display function is no longer needed and the article has been removed from the display case, the invention returns to its collapsed or dismantled configuration as a bookmark card.

6. The bookmark card of claim 5 is made of cardboard sufficiently thick to form a solid body with a stable structure in its upright configuration and a durable bookmark card in its collapsed configuration.

7. The bookmark card of claim 5 does not require the use of adhesives to assume its upright display configuration.

8. One method for producing the convertible bookmark card is by means of punching the cardboard piece into a suitable length and width by dividing its surface into sections by creases. The lower sections for the base of its upright display case configuration and the upper section as a decorative promotional claim. In the symmetrical lower sections, two openings of a size suitable to properly fasten the article to be presented are punched at their opposite ends. Once the lower sections are folded and the openings are aligned they are joined by inserting the article to be presented.
